(19) United States
(12) Patent Application Publication
(10) Pub. No.: US 2005/0244093 A1
(43) Pub. Date: Nov. 3, 2005

(54) Wavelength-tuned intensity measurement of surface plasmon resonance sensor

(76) Inventors: Gregory D. VanWiggeren, San Jose, CA (US); Daniel B. Roitman, Menlo Park, CA (US)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/838,790

(22) Filed: May 3, 2004

(51) Int. Cl. G02B 6/00

(52) U.S. Cl. 385/12

(57) ABSTRACT

An incident signal illuminates an SPR sensor over a wavelength range. Intensity of a reflected signal from the SPR sensor is detected with wavelength discrimination imposed on the incident signal or the reflected signal. The wavelength discrimination is imposed at a predesignated tuning rate within the wavelength range. The detected intensity is then sampled at a sampling rate and an intensity profile associated with the SPR sensor is established from the sampling with a wavelength resolution determined by the tuning rate and the sampling rate.

### BACKGROUND OF THE INVENTION

Surface Plasmon Resonance (SPR) relates to optical excitation of surface plasmon waves along an interface between a conductive film and an adjacent dielectric. At resonance, energy from an incident optical signal is coupled to a surface plasmon wave, resulting in a decrease, or dip, in the intensity of an optical signal that is reflected at the conductive film. The optical wavelength at which the dip occurs, referred to as the resonant wavelength, is sensitive to changes in the refractive index of the dielectric that is adjacent to the conductive film. This sensitivity to changes in refractive index enables the dielectric to be used as a sensing medium, for example to detect and identify biological analytes, or for biophysical analysis of biomolecular interactions. There is a need for measurement schemes that increase the accuracy with which changes in refractive index can be detected. In addition, there is a need for measurement schemes that are scalable for use with analytical systems that include arrays of samples for biochemical sensing.

### SUMMARY OF THE INVENTION

According to the embodiments of the present invention, an incident signal illuminates an SPR sensor over a wavelength range. Intensity of a reflected signal from the SPR sensor is detected with wavelength discrimination imposed on the incident signal or the reflected signal. The wavelength discrimination is imposed at a predesignated tuning rate within the wavelength range. The detected intensity is then sampled at a sampling rate and an intensity profile associated with the SPR sensor is established from the sampling with a wavelength resolution determined by the tuning rate and the sampling rate.

### BRIEF DESCRIPTION OF THE DRAWINGS

FIG. 1 shows an SPR sensor.

FIG. 2 shows exemplary intensity profiles of reflected optical signals associated with an SPR sensor.

FIG. 3 shows sensitivity, versus wavelength, of resonant wavelength to refractive index.

FIG. 4 shows exemplary intensity profiles of reflected optical signals associated with an SPR sensor.

FIGS. 5-6 show optical systems according to embodiments of the present invention.

FIGS. 7A-7B show optical systems according to alternative embodiments of the present invention.

FIG. 8 shows a flow diagram of a measurement method according to alternative embodiments of the present invention.

### DETAILED DESCRIPTION OF THE EMBODIMENTS

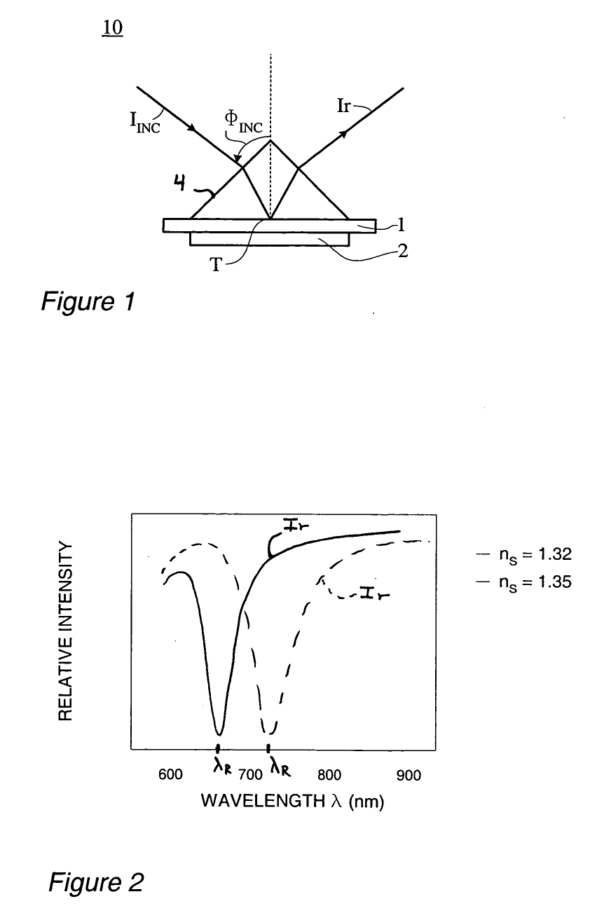

FIG. 1 shows an SPR sensor 10 that includes a conductive film 1 adjacent to a dielectric 2. In some SPR sensors 10 the dielectric 2 is a sensing medium, and a linker layer (not shown) is interposed between the conductive film 1 and the dielectric 2 to provide a site for bio-molecular receptors to attach. For clarity, the conductive film 1 in FIG. 1 is shown adjacent to the dielectric 2 without the linker layer. A prism 4 is positioned adjacent to a side of the conductive film 1 that is opposite the dielectric 2. Features of the SPR sensor 10 are described in a variety of references, including Simulation and Analysis of Surface Plasmon Resonance Biosensor Based on Phase Detection, Sensors and Actuators B vol. 91, Xinglong Yu et al. (2003), p285-290.

In a typical SPR sensor 10, the conductive film 1 is a gold layer having an appropriate thickness for an incident optical signal, hereafter signal I_{INC}, at a designated angle of incidence φ_{INC} and wavelength, to excite a surface plasmon wave, or surface plasmon, along the conductive film 1. Associated with the surface plasmon is an evanescent tail (not shown) that penetrates into the dielectric 2. Energy in the signal I_{INC} that is not coupled into the surface plasmon is reflected at the conductive film 1 to provide a reflected optical signal, hereafter signal Ir.

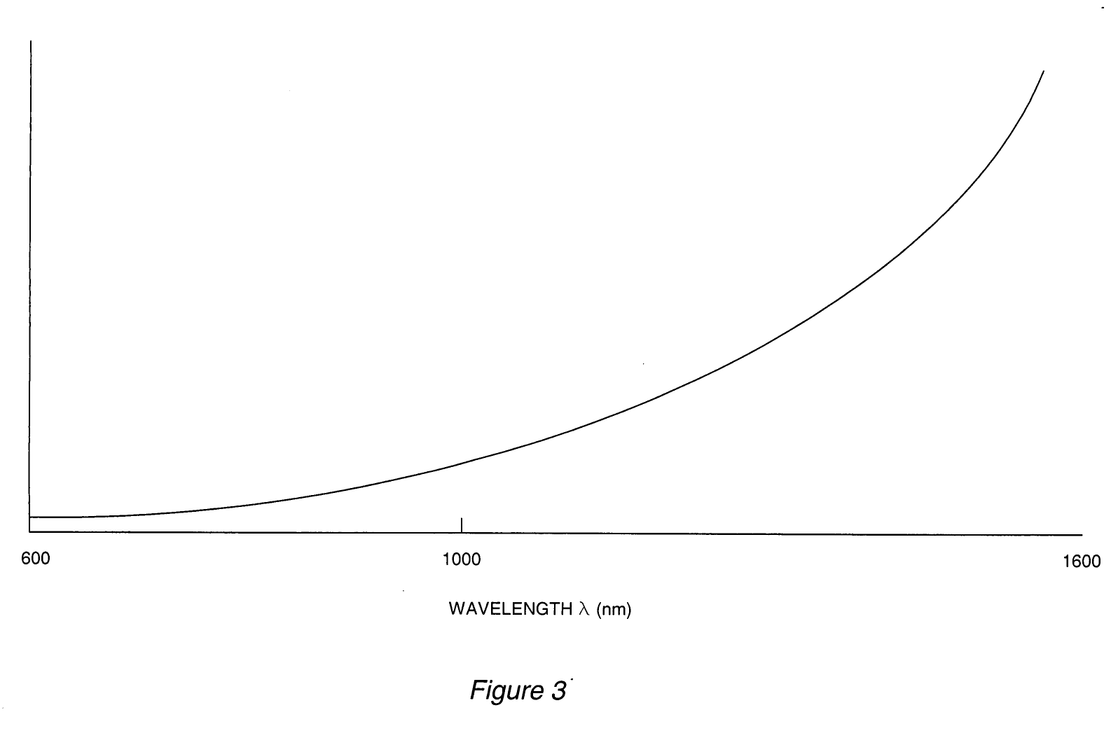

Coupling between the signal I_{INC} and the surface plasmon results in a decrease, or dip, in the intensity of the signal Ir. The optical wavelength at which the dip occurs, referred to as the resonant wavelength λ_{R}, is indicated in FIG. 2 which shows exemplary intensity profiles. These intensity profiles show the relative intensity of the signal Ir versus the wavelength λ of the signals I_{INC}, Ir and indicate that the intensity of the signal Ir is sensitive to the wavelength λ of the signals I_{INC}, Ir in the vicinity of the resonant wavelength λ_{R}. The resonant wavelength λ_{R}, in turn, is sensitive to changes Δn in refractive index n_{S} of the dielectric 2, due to the penetration of the evanescent tail into the dielectric 2. Establishing the intensity profile of the signal Ir enables the resonant wavelength λ_{R} to be identified, and enables shifts Δλ in the resonant wavelength λ_{R} to be detected. Detected shifts Δλ in the resonant wavelength λ_{R} can be mapped to changes Δn in refractive index n_{S} of the dielectric 2 that cause the shifts Δλ in the resonant wavelength λ_{R}. In the exemplary intensity profiles of FIG. 2, at a designated angle of incidence φ_{INC}, a detected shift Δλ of 60 nm in the resonant wavelengths λ_{R} results from a change Δn in the refractive index n_{S} of the dielectric 2 from 1.32 to 1.35 refractive index units.

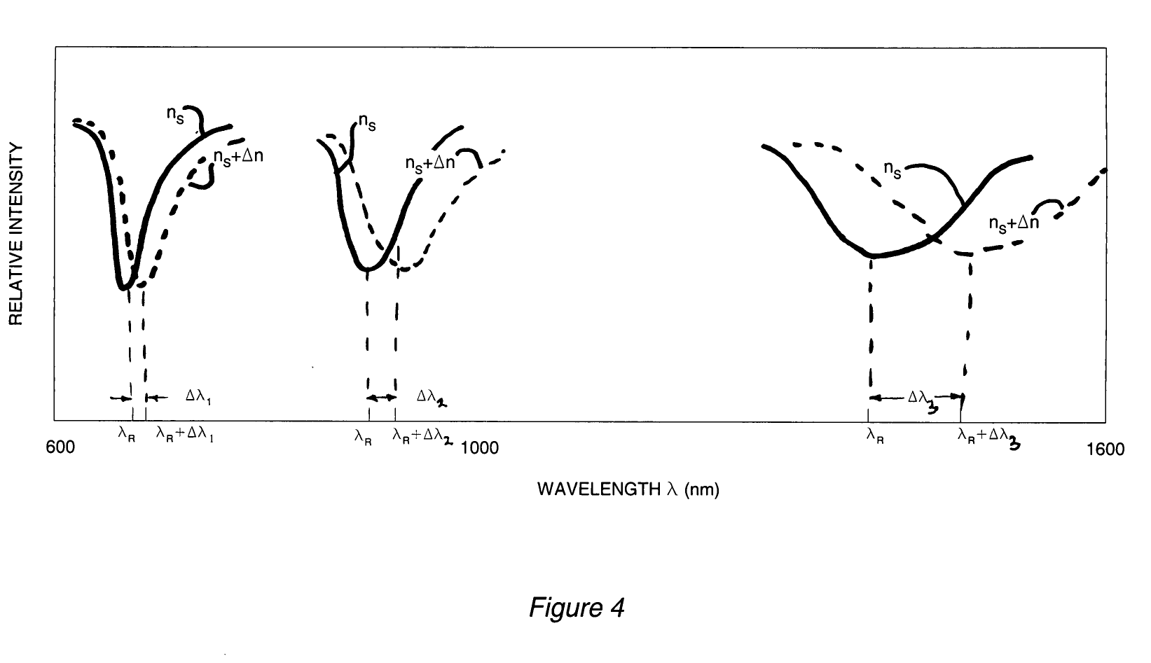

FIG. 3 shows that at longer optical wavelengths, the resonant wavelength λ_{R} has higher sensitivity to changes Δn in the refractive index n_{S} of the dielectric 2. Thus, as the wavelength λ of the signals I_{INC}, Ir increase, the sensitivity of resonant wavelength λ_{R} to refractive index n_{S} (indicated by the derivative dλ/dn) correspondingly increases, which results in a larger shift Δλ in resonant wavelength λ_{R} for each given change Δn in refractive index n_{S}.

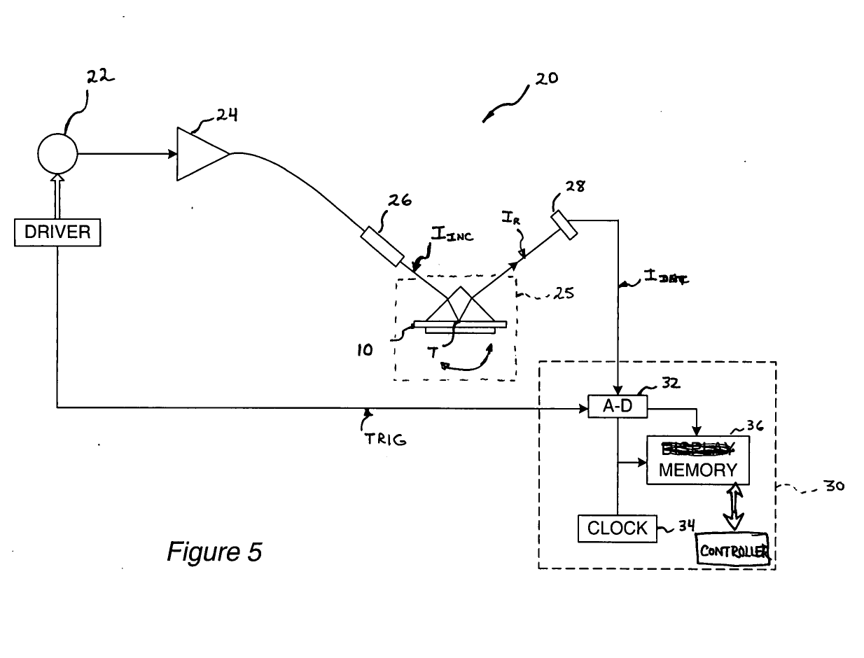

FIG. 4 shows exemplary intensity profiles that indicate the relative intensity of the signal Ir versus the optical wavelength λ of the signals I_{INC}, Ir at designated angles of incidence of signals φ_{INC} of the signal I_{INC}. At longer wavelengths, larger shifts Δλ in resonant wavelength λ_{R} result for a given change Δn in refractive index n_{S}. In the example shown in FIG. 4, for a given change Δn in refractive index n_{S}, shifts Δλ in resonant wavelength λ_{R} get progressively larger, from a shift Δλ₁ to a shift Δλ₃, as wavelength λ of the signals I_{INC}, Ir increases. FIG. 4 also indicates that while the sensitivity dλ/dn increases at longer wavelength λ, the dips in relative intensity become broader and less pronounced at the longer wavelengths, which makes it more difficult to accurately detect the resonant wavelength λ_{R} of the SPR sensor 10 using conventional techniques. Surface Plasmon Resonance Biosensors, by Homola et al., in Optical Biosensors: Present and Future, edited by F. S. Ligler and C. A. Rowe Taitt, ISBN 0444509747, page 244, reports that narrow dips in intensity provide higher accuracy and resolution for SPR-based sensors.

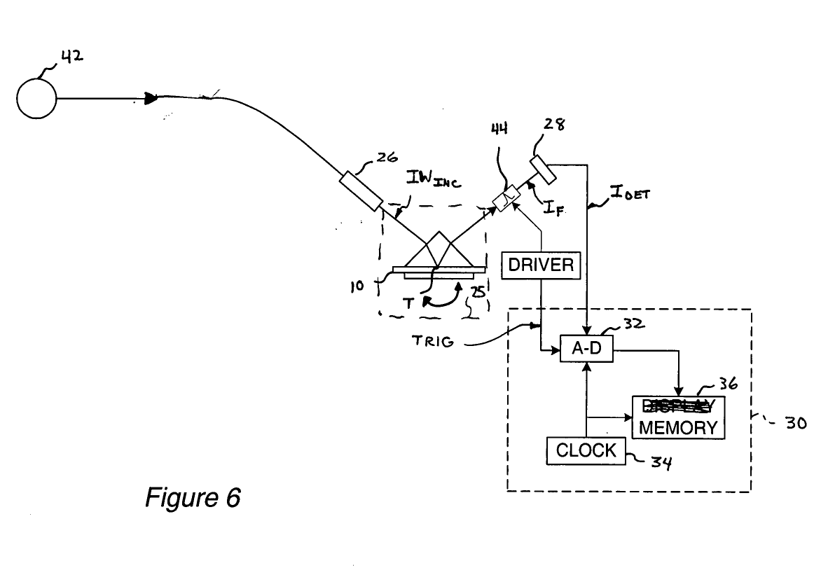

FIG. 5 shows an optical system 20 according to embodiments of the present invention. The optical system 20 is suitable for establishing intensity profiles associated with the SPR sensor 10, for detecting the resonant wavelength λ_{R} of an SPR sensor 10, or for detecting shifts Δλ in resonant wavelength λ_{R}, such as shifts Δλ induced by changes Δn in refractive index n_{S} of the dielectric 2 in an SPR sensor 10. In a typical application of the optical system 20, shifts Δλ in the resonant wavelength λ_{R} are detected and mapped to the changes Δn in refractive index n_{S} of the dielectric 2 that induce the shifts Δλ.

The optical system 20 includes a tunable optical source 22, typically a tunable laser such as an AGILENT TECHNOLOGIES, INC. model 81680B, that can be tuned at a tuning rate γ within a wavelength range λ₁λ₂. The wavelength range λ₁λ₂ in this example spans from at least 1492-1640 nanometers. Spectral bandwidth of the signal I_{INC} provided by the tunable optical source 22 in the optical system is typically less than 100 kHz, which is typically narrower than the shifts Δλ in the resonant wavelength λ_{R}detected or measured by the optical system 20. The tunable optical source 22 is alternatively implemented with a tunable optical filter (not shown) cascaded with a white light or other broadband optical source (not shown) to provide a signal I_{INC} that is spectrally narrow and tunable over the wavelength range λ₁-λ₂. Examples of tunable optical filters suitable for use in this type of tunable optical source 22 are available from MICRON OPTICS, Inc., Atlanta, Ga., USA.

An erbium-doped fiber amplifier (EDFA), or other type of optical amplifier 24, is optionally cascaded with the tunable optical source 22 to increase the power of the signal I_{INC} that illuminates a region, or target T, of the SPR sensor 10. A collimator 26, or other beam-conditioning element, coupled to the tunable optical source 22 directs the signal I_{INC} to the target T. Typically, the signal I_{INC} includes a p-polarized lightwave and an s polarized lightwave that is orthogonal to the p polarized lightwave, where p, s refer to the conventionally defined polarizations p, s. The signal I_{INC} can also be designated to be p polarized by including a polarization controller (not shown) in the signal path between the tunable optical source 22 and the collimator 26. At a designated angle of incidence φ_{INC}, the signal I_{INC} couples to the surface plasmon and causes the signal Ir to undergo the dip in intensity at the resonant wavelength λ_{R}, shown for example in the intensity profiles of FIG. 2 and FIG. 4. While the optical system 20 is shown implemented using optical fiber in the optical path between the tunable optical source 22 and the collimator 26, free-space optics are alternatively used in this optical path to illuminate the target T of the SPR sensor 10. In these embodiments, spatially separated quarter-wave plates and half-wave plates interposed between the tunable optical source 22 and the target T can be used to provide polarization adjustment to achieve a p polarized signal I_{INC}. Polarization adjustment is alternatively provided via a polarization controller (not shown) interposed in the fiber optic signal path at the output of the tunable optical source 22.

A detector 28 intercepts the signal I_{R} as the wavelength λ of the tunable optical source 22 is tuned within a wavelength range λ₁-λ₂ that includes the resonant wavelength λ_{R} of the SPR sensor 10. When the resonant wavelength λ_{R} occurs outside the wavelength range λ₁-λ₂, the angle of incidence φ_{INC} can be adjusted so that at an adjusted angle of incidence, the resonant wavelength λ_{R} falls within the wavelength range λ₁-λ₂. Adjusting the angle of incidence φ_{INC} is typically enabled by mounting the SPR sensor 10 on a rotation stage 25.

The detector 28 is typically a photodiode, photosensor or other transducer suitable for converting an intercepted optical signal into a corresponding electrical signal, hereinafter referred to as detected signal I_{DET}. The detected signal I_{DET} is provided to a processing unit 30 that in this example includes an analog to digital converter 32 that acquires samples of the detected signal I_{DET}. This acquisition of the samples is triggered by a trigger signal TRIG provided by the tunable optical source 22, which indicates initiation of the tuning or sweeping of the tunable optical source 22. The rate of the sample acquisitions, or sample rate, is determined by a clock rate f_{CLOCK} established by a clock 34. The acquisitions result in a set S of samples of the detected signal I_{DET} that is stored in a memory 36. Samples Si in the set S represent the detected intensity of the signal Ir at the wavelengths λi of the tunable optical source 22. Each integer sample number i corresponds to a wavelength λi within the wavelength range λ₁-λ₂. For example, the wavelength λi of the sample number i of the sample Si in the set S of samples is determined by the relationship λi=λ₁+(γ/f_{CLOCK})i.

Although the detector 28 is typically a broadband detector, to accommodate the wavelength range λ₁-λ₂ of the tunable optical source, the signal Ir intercepted by the detector is spectrally narrow at the wavelengths of the samples Si, so that wavelength resolution of the acquired samples Si in the set S is not compromised by the spectral width of the signal Ir. With the wavelength λ of the tunable optical source 22 being swept or tuned at the tuning rate γ, the wavelength resolution with which the samples Si in the set S are acquired is based on the ratio of the clock rate f_{CLOCK} and the tuning rate γ. Increasing the clock rate f_{CLOCK} relative to the tuning rate γ increases the wavelength resolution, enabling the intensity of the signal Ir to be accurately represented in an intensity profile as a function of wavelength λ. Curve fitting, averaging or applying other signal processing techniques to the acquired set S of samples enables an accurate representation of an intensity profile associated with the SPR sensor 10. These signal processing techniques are readily performed via a computer or other type of processor (not shown) coupled to the memory 36.

The intensity profile enables an accurate determination of the resonant wavelength λ_{R} of the SPR sensor 10, which can be used to accurately determine the resonant wavelength λ_{R} of the SPR sensor 10, or shifts Δλ in the resonant wavelength λ_{R}, such as those shifts Δλinduced by changes Δn in the refractive index n_{S} of the dielectric 2 of the SPR sensor 10. For example, resonant wavelength λ_{R} can be determined from derivatives of the intensity profile to find the minimum of the intensity profile that corresponds to the resonant wavelength λ_{R}, or from any other suitable technique for identifying the resonant wavelength λ_{R} at the dip in the intensity profile. Shifts Δλ in the resonant wavelength λ_{R} between two or more intensity profiles can be detected and quantified by determining the difference in resonant wavelengths λ_{R} of the two or more intensity profiles. Shifts in the intensity profile can also be associated with a change in one or more attributes of the SPR sensor such as a change in refractive index in a sensing medium of the SPR sensor 10.

The detected shifts Δλ in the resonant wavelength λ_{R} detected from the samples of the detected signal I_{DET} can then be mapped to changes Δn in refractive index n_{S} of the dielectric 2 that induce the shifts Δλ in the resonant wavelength λ_{R}. In one example, mapping between the shifts Δλ and the changes Δn is established from computer simulation of the SPR sensor 10 using MATLAB or other suitable program or environment that solves the Fresnel reflections at the interface between the conductive film 1 and the dielectric 2. The computer simulation models the sensitivity dλ/dn_{S} of the resonant wavelength λ_{R} to refractive index n_{S}. From the sensitivity dλ/dn_{S}, each shift Δλ in resonant wavelength λ_{R} can be mapped to a corresponding change Δn in refractive index n_{S}. In another example, multiple targets T having dielectrics 2 with different known refractive indices n_{S1}, n_{S2} . . . n_{Sx} are illuminated sequentially or simultaneously by optical signals I_{INC1}, I_{INC2} . . . I_{INC3} at wavelengths λ in the vicinity of the resonant wavelength λ_{R}. From detection and sampling of reflected optical signals Ir₁, Ir₂ . . . Irₓ by the detector and processing unit of the optical system, resonant wavelengths λ_{R1}, λ_{R2} . . . λ_{RX} corresponding to each of the refractive indices n_{S1}, n_{S2} . . . n_{Sx} are determined. Curve-fitting of the resonant wavelengths λ_{R1}, λ_{R2} . . . λ_{RX} to refractive indices n_{S1}, n_{S2} . . . n_{Sx}, interpolation, or other suitable techniques are then used to establish a mapping between shifts Δλ in resonant wavelength λ_{R} and changes Δn in refractive index n_{S}.

The mapping between shifts Δλ in resonant wavelength λ_{R} and changes Δn in refractive index n_{S} can also be established by matching appropriate wave vectors at the interface between the conductive film 1 and the dielectric 2. This includes equating the wave vector k_{SPR}=w/c ((ε₁n_{S}²)(ε₁+n_{S}²))^{1/2} of the surface plasmon to the wave vector kx=n₄(2π/λ)sinφ_{INC} of the optical signal I_{INC}, where ε₁ is the dielectric constant of the conductive film 1, where n₄ is the refractive index of the prism 4, and where φ_{INC} is the angle of incidence of the optical signal Ic. The change Δn in refractive index n_{S} can be derived from the equation of the wave vectors k_{SPR}, kx, as equation (1), where the imaginary component of the dielectric constant ε₁ of the conductive film 1 is set to zero.

$$Δ n = \frac{Δ λ ( \frac{{n}_{4} {n}_{S}^{3}}{λ} ( \frac{1}{{ɛ}_{1}} - 1 ) + \frac{ⅆ {n}_{4}}{ⅆ λ} {n}_{S} ( {n}_{S}^{2} + {ɛ}_{1} ) )}{{n}_{4} {ɛ}_{1}} \qquad ( 1 )$$

The alternatives presented for mapping detected shifts in the resonant wavelength to changes Δn in refractive index n_{S} are exemplary. It is appreciated that any suitable scheme is alternatively used to establish this mapping.

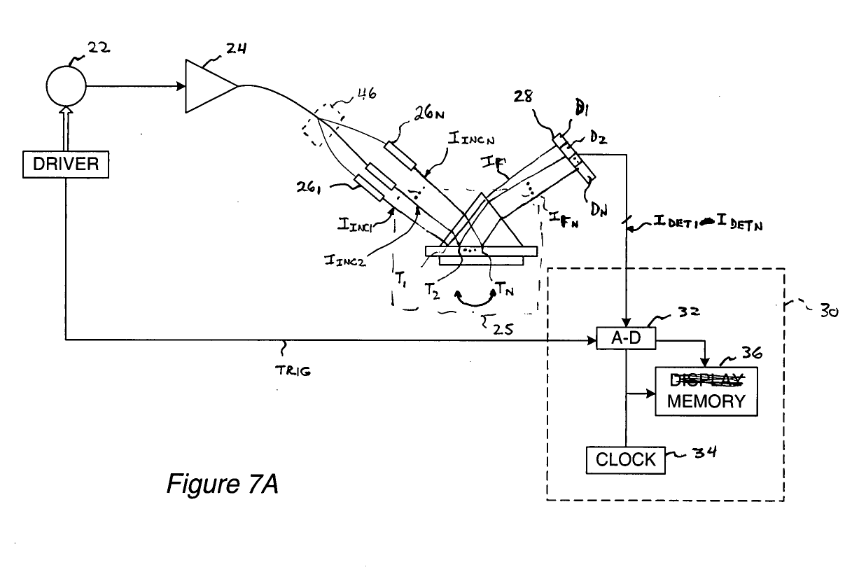

According to an alternative embodiment of the present invention shown in FIG. 6, a white light or other spectrally broad optical source 42 within an optical system provides a signal IW_{INC} that illuminates the SPR sensor 10. A signal IWr is reflected at the target T of the SPR sensor 10 and then filtered by a tunable optical filter 44 interposed between the SPR sensor 10 and the detector 28. The tunable optical filter 44, such as a diffraction grating or filters available from OMEGA OPTICAL, Inc., Brattleboro, Vt., USA, has a spectrally narrow passband and is tunable within the wavelength range λ₁-λ₂.

In one embodiment, the detector 28 intercepts a resulting filtered signal I_{F} from the tunable optical filter 44 as the passband of the tunable optical filter 44 is tuned within a wavelength range λ₁-λ₂ that includes the resonant wavelength λ_{R} of the SPR sensor 10. When the resonant wavelength λ_{R} occurs outside the wavelength range λ₁-λ₂, the angle of incidence φ_{INC} of the signal IW_{INC} can be adjusted via the rotational stage 25 so that at an adjusted angle of incidence, the resonant wavelength λ_{R} falls within the wavelength range λ₁-λ₂. In response to the intercepting the filtered signal I_{F}, the detector 28 produces the signal I_{DET}. The detected signal I_{DET} is then provided to the processing unit 30, which acquires the set S of samples. As with the embodiment shown in FIG. 5, the set S of samples is processed to establish an intensity profile associated with the SPR sensor 10 to detect the resonant wavelength λ_{R} of the SPR sensor 10, or to detect shifts Δλ in the resonant wavelength λ_{R} of the SPR sensor 10 resulting from changes Δn in refractive index n_{S}. The shifts Δλ in the resonant wavelength λ_{R} can then be mapped to changes Δn in refractive index n_{S}.

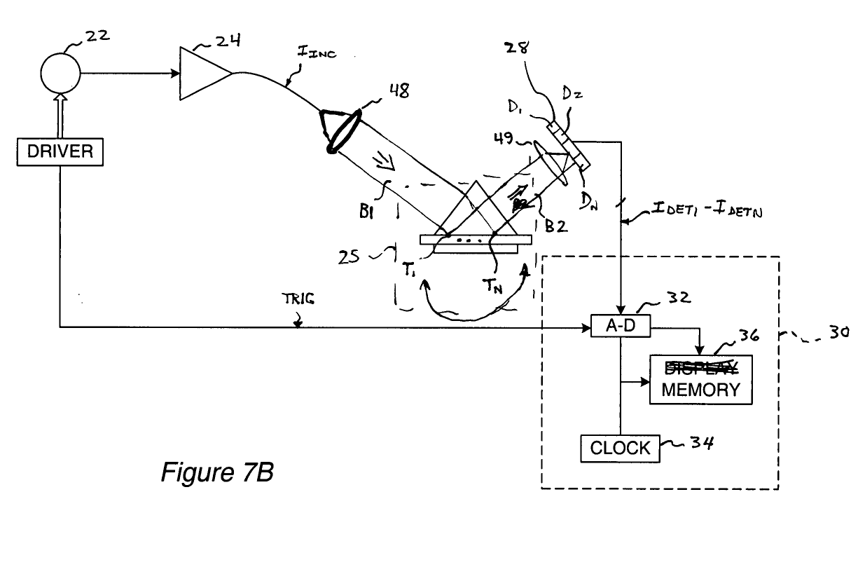

Alternative embodiments of the present invention, shown in FIGS. 7A-7B, enable simultaneous or sequential detection of induced shifts Δλ in resonant wavelength λ_{R} from an array of targets T₁-T_{N} included in one or more SPR sensors 10. In FIG. 7A, the targets T₁-T_{N} are illuminated by optical signals I_{INC1}-I_{INCN} provided from an optical signal I_{INC} by an optical splitter 46 and directed via collimators 26₁-26_{N}. An imaging element, such as a lens (not shown) is optionally interposed between the array of targets T₁-T_{N} and an array of detector elements D₁-D_{N} in the detector 28, such as a photodiode array. When included, the imaging element provides a mapping or other correspondence between the physical locations of the targets T₁-T_{N} and physical locations of detector elements D₁-D_{N} in the detector array, so that optical signals Ir₁-Ir_{N} reflected from the array of targets T₁-T_{N} are intercepted by corresponding detector elements D₁-D_{N} in the detector array to provide detected signals I_{DET1}-I_{DETN}. When the beams of the optical signals Ir₁-Ir_{N} reflected from the array of targets T₁-T_{N} are spatially distinct, a correspondence between the array of targets T₁-T_{N} and the array of detector elements D₁-D_{N} is provided via the optical signals Ir₁-Ir_{N}. When the beams of the optical signals Ir₁-Ir_{N} reflected from the array of targets T₁-T_{N} overlap and are not spatially distinct, a physical mapping or other correspondence between the array of targets T₁-T_{N} and the array of detector elements D₁-D_{N} can be provided by interposing the imaging element between the array of targets T₁-T_{N} and the array of detector elements D₁-D_{N}.

The detected signals I_{DET1}-I_{DETN} from the array of detector elements D₁-D_{N} are then provided to the processing unit 30, which acquires sets S₁-S_{N} of samples that correspond to each of the targets T₁-T_{N}. As with the embodiment shown in FIG. 5, the sets S₁-S_{N} of samples are processed to determine the resonant wavelengths λ_{R}, or shifts Δλ in the resonant wavelengths λ_{R} of the targets T₁-T_{N} resulting from changes in refractive indices of the targets T₁-T_{N}. The shifts Δλ in the resonant wavelength λ_{R} can then be mapped to changes Δn in refractive index n_{S}.

According to the embodiment of the present invention shown in FIG. 7B, a collimating element 48, such as a lens forms a beam B1 from the optical signal I_{INC} that is suitably wide to illuminate an array of targets T₁-T_{N}. In the example shown, spatially separated quarter-wave plates and half-wave plates (not shown) can be interposed between the tunable optical source and the array of targets T₁-T_{N} to provide polarization adjustment to achieve a p polarization of the beam B1. Polarization adjustment is alternatively provided via a polarization controller (not shown) interposed in the fiber optic signal path at the output of the tunable optical source 22. At the array of targets T₁-T_{N} a beam B2 is reflected. An imaging element 49, positioned in the optical path between the array of targets T₁-T_{N} and the detector 28, provides a correspondence between the physical locations of the targets T₁-T_{N} and physical locations of detector elements D₁-D_{N} in the detector 28, so that portions of the beam B2 reflected from the corresponding targets positioned within the array of targets T₁-T_{N} are intercepted by corresponding detector elements D₁-D_{N} in the detector 28 to provide detected signals I_{DET1}-I_{DETN}. As with the embodiment shown in FIG. 7A, the sets S₁-S_{N} of samples are processed to determine the resonant wavelengths λ_{R}, or shifts Δλ in the resonant wavelengths λ_{R} of the targets T₁-T_{N} resulting from changes Δn₁-Δn_{N} in refractive indices of the targets T₁-T_{N}. The shifts Δλ in the resonant wavelength λ_{R} can then be mapped to changes Δn in refractive index n_{S}.

In the examples presented, shifts Δλ in resonant wavelength λ_{R} have been mapped to changes Δn in refractive index n_{S} of the dielectric 2. These changes Δn in refractive index n_{S} can then be used to detect and identify biological analytes, or for biophysical analysis of biomolecular interactions. However, according to alternative embodiments of the present invention, the shifts Δλ in the resonant wavelength λ_{R} are mapped to the presence or identity of biological analytes, to biophysical analyses of biomolecular interactions, or to any suitable attributes or features of the SPR sensor 10 that induce the shifts Δλ in the resonant wavelength λ_{R}.

Conventional SPR sensing techniques provide for detection of small and medium size analytes, with large analytes being difficult to detect. Surface Plasmon Resonance Biosensors, by Homola et al., page 243, reports that the sensitivity of conventional sensor techniques is not adequate for detecting larger analytes, such as bacteria and cells. However, the embodiments of the present invention accommodate longer wavelengths λ within the wavelength range λ₁-λ₂ over which the signal I_{INC} illuminates the SPR sensor 10. These longer wavelengths provide correspondingly deeper penetration of the evanescent field into the dielectric 2 of the SPR sensor 10, which enables larger analytes to be detected, identified, monitored, or otherwise measured using the optical systems and methods according to the embodiments of the present invention.

According to the embodiments of the present invention, the resonant wavelength associated with the SPR sensor 10 is typically the wavelength at which the dip in the intensity profile occurs, as shown for example in FIGS. 2 and 4. However, the resonant wavelength λ_{R} associated with the SPR sensor 10 is alternatively any other designated measurement wavelength, such as one or more wavelengths λ offset from the actual resonant wavelength at which the dip in the intensity profile occurs. These measurement wavelengths can be used to detect shifts Δλ in the resonant wavelength λ_{R}, such as those shifts Δλ due to changes in the refractive index n_{S} of the dielectric 2.

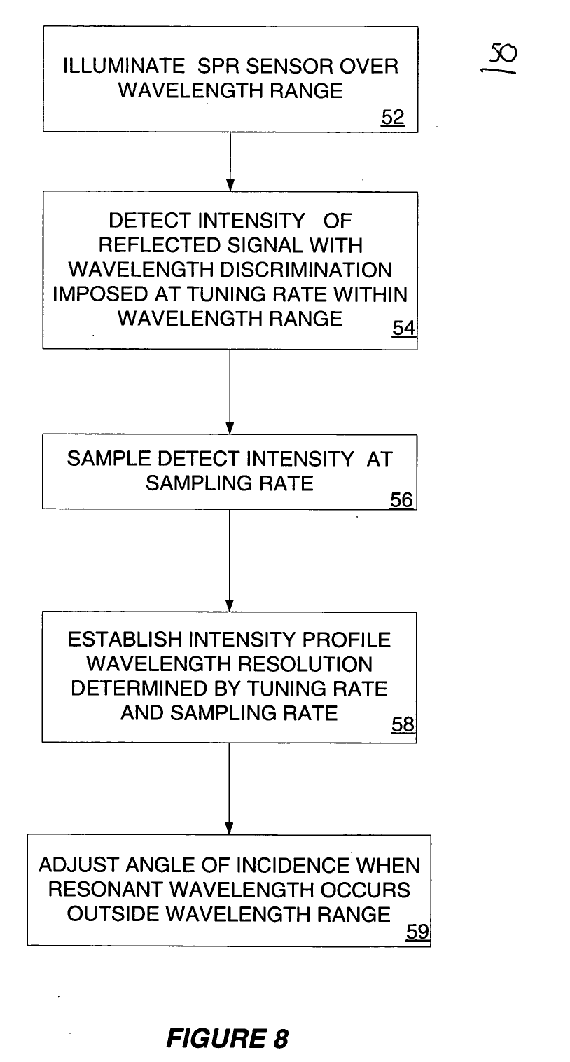

FIG. 8 shows a measurement method 50 according to alternative embodiments of the present invention. The measurement method 50 includes illuminating the SPR sensor 10 over the wavelength range λ₁-λ₂ with an incident optical signal, such as the signals I_{INC}, IW_{INC} (step 52). In step 54 of the measurement method 50, the intensity of the reflected signal from the SPR sensor is detected with wavelength discrimination imposed, at a pre-established tuning rate within the wavelength range λ₁-λ₂, on the incident signal or the reflected signal. Wavelength discrimination is imposed on the incident signal I_{INC} by generating the incident signal with the tunable optical source 22. Alternatively, wavelength discrimination is imposed on the incident signal I_{INC} via a tunable optical filter interposed between an optical source generating the incident signal and the SPR sensor 10. Wavelength discrimination is imposed on the reflected signal via the tunable optical filter 44 interposed between the SPR sensor 10 and the detector 28 detecting the intensity of the reflected signal from the SPR sensor 10.

Step 56 of the measurement method 50 includes sampling the detected intensity at a sampling rate. Step 58 includes establishing an intensity profile associated with the SPR sensor from the sampling of step 56, where the intensity profile has a wavelength resolution determined by the tuning rate Δ and the sampling rate. The measurement method 60 optionally comprises step 59, which includes adjusting the angle of incidence of the incident signal on the SPR sensor 10 when an identified resonant wavelength λ_{R} associated with the SPR sensor 10 occurs outside the wavelength range λ₁-λ₂, so that at an adjusted angle of incidence, the resonant wavelength λ_{R} of the SPR sensor 10 falls within the designated wavelength range λ₁-λ₂.

While an SPR sensor 10 has been included in the embodiments of the present invention, SPR sensors in these embodiments are meant to include resonant mirror transducers, or any other type of transducer providing reflected optical signals Ir having associated intensity profiles dependent on attributes of a sensing medium that are sensed by penetration of an evanescent wave into the sensing medium.

While the embodiments of the present invention have been illustrated in detail, it should be apparent that modifications and adaptations to these embodiments may occur to one skilled in the art without departing from the scope of the present invention as set forth in the following claims.

1. An optical system, comprising:
a tunable optical source providing an incident signal illuminating an SPR sensor;
a detector detecting the intensity of a reflected signal from the SPR sensor as the incident signal is tuned at a tuning rate over a designated wavelength range; and
a processing unit, coupled to the detector, sampling the detected intensity at a sampling rate and establishing an intensity profile associated with the SPR sensor from the sampling of the detected intensity with a wavelength resolution based on the tuning rate and the sampling rate.

2. The optical system of claim 1 wherein the tunable optical source includes a tunable laser.

3. The optical system of claim 1 wherein the tunable optical source includes a tunable optical filter cascaded with a broadband optical source.

4. The optical system of claim 1 wherein the wavelength resolution of the established intensity profile is based on the ratio of the sampling rate and the tuning rate.

5. The optical system of claim 1 wherein the processing unit identifies a resonant wavelength of the SPR sensor from the established intensity profile.

6. The optical system of claim 5 further comprising a rotation stage adjusting an angle of incidence of the incident signal when the resonant wavelength occurs outside the designated wavelength range so that at an adjusted angle of incidence, the resonant wavelength of the SPR sensor falls within the designated wavelength range.

7. The optical system of claim 5 wherein the processing unit identifies a shift in a resonant wavelength associated with a change in one or more attributes of the SPR sensor.

8. The optical system of claim 7 wherein the identified shift in resonant wavelength corresponds to a change in refractive index in a sensing medium of the SPR sensor.

9. The optical system of claim 1 wherein the processing unit identifies a shift in the established intensity profile associated with a change in one or more attributes of the SPR sensor.

10. The optical system of claim 9 wherein the identified shift in the established intensity profile corresponds to a change in refractive index in a sensing medium of the SPR sensor.

11. An optical system, comprising:
an optical source providing an incident signal illuminating an SPR sensor over a designated wavelength range;
a detector;
a tunable optical filter interposed between the SPR sensor and the detector, the detector detecting the intensity of a reflected signal from the SPR sensor as the tunable optical filter is tuned at a tuning rate within the designated wavelength range; and
a processing unit sampling the detected intensity at a sampling rate, and establishing an intensity profile associated with the SPR sensor from the sampling of the detected intensity with a wavelength resolution established by the tuning rate and the sampling rate.

12. The optical system of claim 11 wherein the wavelength resolution of the established intensity profile is based on the ratio of the sampling rate and the tuning rate.

13. The optical system of claim 11 wherein the processing unit identifies a resonant wavelength of the SPR sensor from the established intensity profile.

14. The optical system of claim 11 wherein the processing unit identifies a shift in the established intensity profile associated with a change in one or more attributes of the SPR sensor.

15. The optical system of claim 14 wherein the identified shift in the established intensity profile corresponds to a change in refractive index in a sensing medium of the SPR sensor.

16. The optical system of claim 13 wherein the processing unit identifies a shift in the resonant wavelength associated with a change in one or more attributes of the SPR sensor.

17. The optical system of claim 16 wherein the identified shift in the resonant wavelength corresponds to a change in refractive index in a sensing medium of the SPR sensor.

18. The optical system of claim 13 further comprising rotation stage adjusting an angle of incidence of the incident signal when the resonant wavelength occurs outside the designated wavelength range so that at an adjusted angle of incidence, the resonant wavelength of the SPR sensor falls within the designated wavelength range.

19. A method, comprising:
illuminating an SPR sensor over a wavelength range with an incident signal;
detecting the intensity of a reflected signal from the SPR sensor with wavelength discrimination imposed at a tuning rate and within the wavelength range, on at least one of the incident signal and the reflected signal;
sampling the detected intensity at a sampling rate; and
establishing an intensity profile associated with the SPR sensor from the sampling with a wavelength resolution determined by the tuning rate and the sampling rate.

20. The method of claim 19 wherein wavelength discrimination is imposed on the incident signal by generating the incident signal with a tunable optical source.

21. The method of claim 19 wherein wavelength discrimination is imposed on the incident signal via a tunable optical filter interposed between an optical source generating the incident signal and the SPR sensor.

22. The method of claim 19 wherein wavelength discrimination is imposed on the reflected signal via a tunable optical filter interposed between the SPR sensor and a detector detecting the intensity of the reflected signal from the SPR sensor.

23. The method of claim 19 further including identifying a resonant wavelength of the SPR sensor from the established intensity profile.

24. The method of claim 19 further including identifying a shift in the established intensity profile associated with a change in one or more attributes of the SPR sensor.

25. The method of claim 24 wherein the identified shift in the established intensity profile corresponds to a change in refractive index in a sensing medium of the SPR sensor.

26. The method of claim 23 further including identifying a shift in the resonant wavelength associated with a change in one or more attributes of the SPR sensor.

27. The method of claim 26 wherein the identified shift in the resonant wavelength corresponds to a change in refractive index in a sensing medium of the SPR sensor.

28. The method of claim 23 further comprising adjusting an angle of incidence of the incident signal when the resonant wavelength occurs outside the designated wavelength range so that at an adjusted angle of incidence, the resonant wavelength of the SPR sensor falls within the designated wavelength range

29. An optical system, comprising:
a tunable optical source providing an incident signal illuminating a series of targets within at least one SPR sensor;
an array of detector elements detecting the intensity of a series of reflected signals from the series of targets as the incident signal is tuned at a tuning rate over a designated wavelength range; and
a processing unit, coupled to the array of detector elements, sampling the detected intensity from each of the detector elements at a sampling rate, and establishing an intensity profile associated with each of the targets in the series from the sampling of the detected intensity from each of the detector elements with a wavelength resolution based on the tuning rate and the sampling rate.

30. The optical system of claim 29 wherein the tunable optical source includes a tunable laser.

31. The optical system of claim 29 wherein the tunable optical source includes a tunable optical filter cascaded with a broadband optical source.

32. The optical system of claim 29 further comprising a collimating element interposed between the tunable optical source and the series of targets.

33. The optical system of claim 29 further comprising an optical splitter and a series of collimaters interposed between the tunable optical source and the series of targets.

34. The optical system of claim 29 further comprising focusing element interposed between the series of targets and the array of detector elements.

35. An optical system, comprising:
an optical source providing an incident signal illuminating a series of targets within at least one SPR sensor an SPR sensor over a designated wavelength range;
an array of detector elements;
a tunable optical filter interposed between the series of targets and the array of detector elements, the array of detector elements detecting the intensity of a series of reflected signal from corresponding targets in the series of targets as the tunable optical filter is tuned at a tuning rate within the designated wavelength range; and
a processing unit sampling the detected intensity from the detector elements in the array of detector elements at a sampling rate, and establishing an intensity profile associated with the series of targets from the sampling of the detected intensity from each of the detector elements with a wavelength resolution established by the tuning rate and the sampling rate.

36. The optical system of claim 35 further comprising focusing element interposed between the series of targets and the array of detector elements.
